(19) United States
(12) Patent Application Publication
(10) Pub. No.: US 2015/0059412 A1
(43) Pub. Date: Mar. 5, 2015

(54) OPTICAL FIBER RIBBONIZATION APPARATUS AND METHOD

(71) Applicant: XIEON NETWORKS S.A.R.L., Luxemburg (LU)

(72) Inventor: Sugianto Wonoadi, Berlin (DE)

(73) Assignee: Xieon Networks S.a.r.l., Luxemburg (LU)

(21) Appl. No.: 14/390,198

(22) PCT Filed: Apr. 5, 2013
(86) PCT No.: PCT/EP2013/057240

§ 371 Date: Oct. 2, 2014

(30) Foreign Application Priority Data
Apr. 5, 2012 (DE) 10 2012 205 723.4

(51) Int. Cl. G02B 6/255

(52) U.S. Cl. CPC G02B 6/2555; G02B 6/2553; G02B 6/2558
USPC 65/407; 385/98

(57) ABSTRACT

Method of ribbonizing a plurality of optical fibers (103) and ribbonizing apparatus for optical fibers, comprising a tablet (101) including fiber aligning means (104, 105) for aligning a plurality of optical fibers (103) in parallel, the ribbonizing apparatus being configured to be movably arranged in a splicing apparatus (102) when the plurality of optical fibers (103) is aligned in the tablet (101), and to be removed from the splicing apparatus (102) after a splicing process, so that the plurality of optical fibers (103) is not damaged due to mechanical stress.

### FIELD OF THE INVENTION

The invention relates to an apparatus for ribbonizing optical fibers and to a ribbonization method for optical fibers.

### BACKGROUND OF THE INVENTION

An apparatus for ribbonizing short optical fibers is known in the practice and manufactured and sold by Furukawa under the name of Furukawa Ribbonization Holder.

Other conventional tools are known in the art, as, for example, 3M™ Fibrlok™ Fiber Optic Ribbon tool, which employs tape as fastening means or the Fujukura ribbonization method which employs glue as fastening means.

All conventional tool, however, suffer from several drawbacks. In particular, they do not allow arranging a plurality of fibers in a splice equipment so that these can be spliced together, removing them from the splice equipment after splicing and arranging them in a splice protector so that the splice points can be protected, without incurring damages due to mechanical stress.

A consequence of this disadvantages is that for conventional ribbonization tools and methods the process reliability is low while the process risk and the process time are high.

The problem to be solved is to overcome the disadvantages stated above and in particular to provide a solution that allows a plurality of fibers to be spliced at the same time and to be removed from a splice equipment and arranged in a splice protector without incurring damages due to mechanical stress.

### SUMMARY OF THE INVENTION

In order to overcome the above-described need in the art, the present invention discloses a ribbonizing apparatus for optical fibers, comprising a tablet including fiber aligning means for aligning a plurality of optical fibers in parallel, the ribbonizing apparatus being configured to be movably arranged in a splicing apparatus when the plurality of optical fibers is aligned in the tablet, and to be re-moved from the splicing apparatus after a splicing process, so that the plurality of optical fibers is not damaged due to mechanical stress.

It is also an embodiment that the ribbonizing apparatus further comprises fastening means for fastening the plurality of optical fibers with the tablet.

In a further embodiment, the ribbonizing apparatus is configured to engage with the splicing apparatus.

In a next embodiment of the invention, the ribbonizing apparatus is configured to be arranged in a splice protector apparatus after having been removed from the splicing apparatus.

In a next embodiment of the invention, the plurality of optical fibers of the ribbonizing apparatus includes at least 12 optical fibers.

The problem stated above is also solved by a method of ribbonizing a plurality of optical fibers, the method comprising the steps of: aligning the plurality of optical fibers on a tablet, arranging the tablet having the plurality of optical fibers aligned on it in a splicing apparatus, splicing the plurality of optical fibers, removing the tablet having the plurality of optical fibers aligned on it from the splicing apparatus.

In a further embodiment, the method further comprises the step of engaging the tablet having the plurality of optical fibers aligned on it with the splicing apparatus.

It is also an embodiment that the plurality of optical fibers is fastened with the tablet.

The method and the apparatus provided, in particular, bears the following advantages:
a) They allow a plurality of fibers to be spliced at the same time and to be removed from a splice equipment and arranged in a splice protector without incurring damages due to mechanical stress.
b) They can be easy implemented.
c) Remarkable performance improvement can be achieved.
d) They reduce the process time.
e) They make it possible to reduce manufacturing costs.
f) They are cost effective.

### BRIEF DESCRIPTION OF THE DRAWINGS

The invention is explained by way of example in more detail below with the aid of the attached drawings.

FIG. 1 is a schematic perspective view of the ribbonizing apparatus according to an embodiment of the invention.

FIG. 2a is a schematic perspective view of the ribbonizing apparatus during a splicing process according to an embodiment of the invention.

FIG. 2b is a schematic perspective view of the tablet when it is removed from the splicing apparatus after a splicing process according to an embodiment of the invention.

FIG. 2c is a schematic perspective view of the ribbonizing apparatus during a heating process according to an embodiment of the invention.

### DESCRIPTION OF THE INVENTION

Illustrative embodiments will now be described with reference to the accompanying drawings to disclose the teachings of the present invention. While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

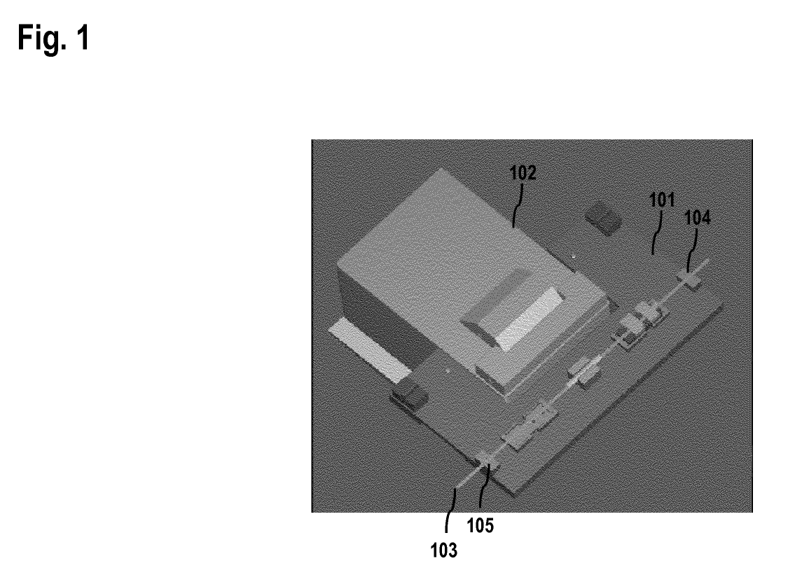

FIG. 1 is a schematic perspective view of the ribbonizing apparatus according to an embodiment of the invention showing a tablet 101 including fiber aligning means 104 and 105 for aligning a plurality of optical fibers 103 in parallel; the ribbonizing apparatus shown in FIG. 1 is arranged in a splicing apparatus 102 and engages with it. The fiber aligning means 104 and 105 may be fastening means and fasten the plurality of optical fibers 103 with the tablet 101. The tablet 101 may include metallic, plastic, carbon or wood material. The plurality of optical fibers may include at least 2 optical fibers. In a further embodiment of the invention, the plurality of optical fibers may include more than 2 optical fibers, for example at least 12 optical fibers.

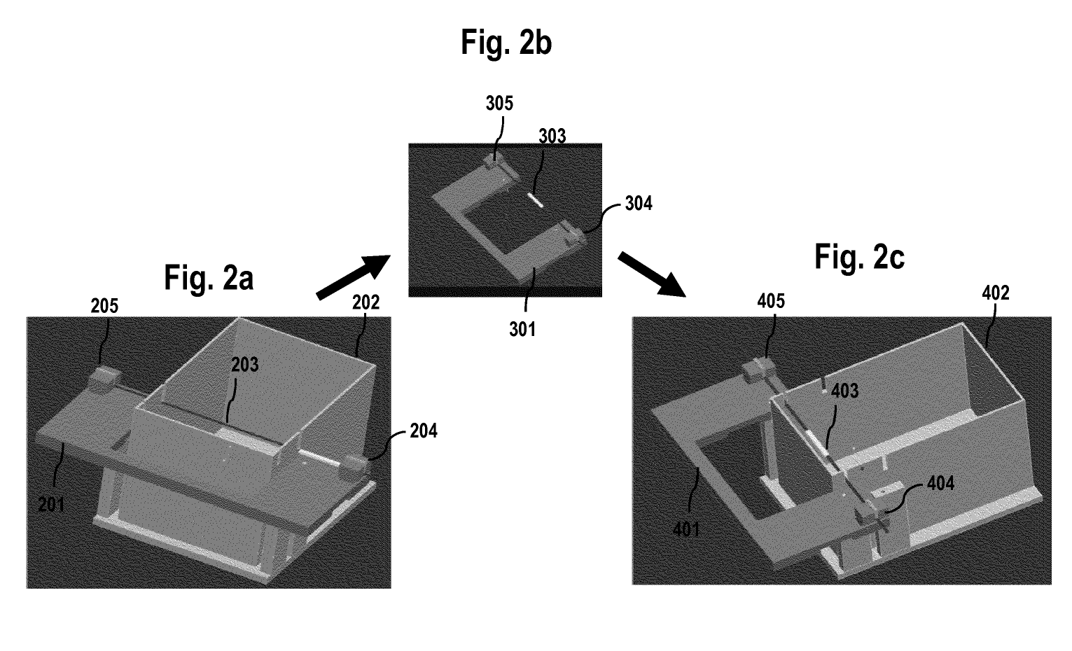

FIG. 2a is a schematic perspective view of the ribbonizing apparatus during a splicing process according to an embodiment of the invention. In particular FIG. 2a shows the tablet 201 including fiber aligning means 204 and 205 for aligning a plurality of optical fibers 203 in parallel;
the ribbonizing apparatus shown in FIG. 2a is arranged in the splicing apparatus 202 and engages with it. The fiber aligning means 204 and 205 may be fastening means and fasten the plurality of optical fibers 203 with the tablet 201.

FIG. 2b is a schematic perspective view of the tablet 301 when it is removed from the splicing apparatus 202 after a splicing process. In this way the plurality of optical fibers 303 aligned on the tablet 301 is not damaged due to mechanical stress. The tablet 301 includes fiber aligning means 304 and 305 for aligning the plurality of optical fibers 303 in parallel. The splice points can be protected by means of splice protector without any substantial mechanical stress.

FIG. 2c is a schematic perspective view of the ribbonizing apparatus during a heating process according to an embodiment of the invention. In particular FIG. 3a shows the tablet 301 including fiber aligning means 304 and 305 for aligning the plurality of optical fibers 303 in parallel;
the ribbonizing apparatus shown in FIG. 3a is arranged in the splicing apparatus 302 and engages with it. The fiber aligning means 304 and 305 may be fastening means and fasten the plurality of optical fibers 303 with the tablet 301.

The ribbonizing apparatus and the method described make it possible enable to splice several single fibers at the same time. In particular it is possible to remove a plurality of fibers after splicing from the splicing apparatus avoiding that the single fibers suffer from substantial mechanical stress before that the splice points can be protected by means of splicing protectors.

The present invention is not limited to the details of the above described principles. The scope of the invention is defined by the appended claims and all changes and modifications as fall within the equivalents of the scope of the claims are therefore to be embraced by the invention. Mathematical conversions or equivalent calculations of the signal values based on the inventive method or the use of analogue signals instead of digital values are also incorporated.

1. A ribbonizing apparatus for optical fibers, comprising:
a tablet including fiber aligning means for aligning a plurality of optical fibers in parallel;
the ribbonizing apparatus being configured to be movably arranged in a splicing apparatus when the plurality of optical fibers is aligned in the tablet, and to be removed from the splicing apparatus after a splicing process, so that the plurality of optical fibers is not damaged due to mechanical stress, wherein the apparatus is configured to be arranged in a splice protection apparatus after having been removed from the splicing apparatus.

2. An apparatus according to claim 1, further comprising fastening means for fastening the plurality of optical fibers with the tablet.

3. An apparatus according to claim 1 wherein the apparatus is configured to engage with the splicing apparatus.

4. (canceled)

5. An apparatus according to claim 1 wherein the plurality of optical fibers includes at least 12 optical fibers.

6. Method of ribbonizing a plurality of optical fibers comprising:
aligning the plurality of optical fibers on a tablet;
arranging the tablet having the plurality of optical fibers aligned on it in a splicing apparatus;
splicing the plurality of optical fibers;
removing the tablet having the plurality of optical fibers aligned on it from the splicing apparatus, and introducing the tablet having the plurality of optical fibers aligned on it to a splice protection apparatus.

7. A method according to claim 6 further comprising:
engaging the tablet having the plurality of optical fibers aligned on it with the splicing apparatus.

8. A method according to claim 6, wherein the plurality of optical fibers is fastened with the tablet.

9. A method according to claim 6, wherein the plurality of optical fibers includes at least 12 optical fibers.
